(19) United States
(12) Patent Application Publication
(10) Pub. No.: US 2009/0322192 A1
(43) Pub. Date: Dec. 31, 2009

(54) AERODYNAMIC STRUCTURAL SAFETY BARRIER DESIGN

(75) Inventors: Brett C. Ong, San Jose, CA (US); Timothy W. Olesiewicz, Dublin, CA (US); Christopher H. Frank, San Jose, CA (US)

Correspondence Address: OSHA LIANG L.L.P./SUN, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 12/163,483

(22) Filed: Jun. 27, 2008

(51) Int. Cl. A47B 81/00; F15D 1/10

(52) U.S. Cl. 312/223.2; 52/84

(57) ABSTRACT

A barrier disposed within a computer housing includes a frame adapted to be secured to the computer housing; and a plurality of elongated members attached to the frame. The plurality of elongated members are disposed across the frame such that the plurality of elongated members are attached to an inner surface of the frame. The barrier defines separate compartments within the computer housing and at least one fan is disposed in a compartment separated by the barrier from another compartment in which at least one electronic component is disposed. A method of manufacturing a barrier includes providing a frame; attaching a plurality of elongated members to the frame; disposing the frame within the housing such that the frame defines separate compartments within the housing; disposing at least one fan in a compartment separated by the barrier from another compartment; and disposing at least one electronic component in the another compartment.

### BACKGROUND OF DISCLOSURE

### BACKGROUND ART

Fans are an integral component in cooling modem computer systems. In order to comply with safety standards in place with respect to fans, fan enclosures are required to prevent injuries resulting from fans during, for example, service of computer systems. Product safety testing companies, such as Underwriter Laboratories, perform certification testing on fan enclosures to ensure they meet safety standards.

One general rule for ensuring safety is the so-called “finger test,” wherein any fan enclosure that prevents a finger from accidentally contacting a moving fan is considered sufficiently safe. Those skilled in the art will appreciate that many different designs exists that meet the finger test. However, those skilled in the art will also appreciate that such designs must also be made to not overly impede the airflow of the fan.

Typically, a barrier or partition is disposed within the computer to define separate compartments within the computer to, e.g., protect a user from accidental contact with the blades of fans. However, there must be holes formed within these barriers or partitions to allow airflow within the computer.

As shown in FIG. 1, a perspective view of a typical prior art barrier 101 is shown. The barrier 101 includes multiple holes 103 formed therein, in which wire guards 105 are disposed over the large holes 103. The barrier 101 is then positioned within a computer to separate any of the components internal to the computer. The holes 103 are used to facilitate airflow within the computer, while the wire guards 105 are used to prevent objects, e.g., a user's fingers, from being able to come across the barrier 101. Thus, the wire guards 105 protect users who are servicing the computer from accidentally contacting the blades of fans disposed in the computer.

However, with the large holes 103 formed within the barrier 101, the structural strength of the barrier 101 may be decreased. For example, these large holes 103 may be stress concentrations within the barrier 101. As such, when under large amounts of stress, stress may concentrate at the large holes 103 and cause the barrier 101 to fail at or around the large holes 103. Further, though the large holes 103 provide for some airflow across the barrier 101, the barrier 101 may still impede a significant amount of air from having an opportunity to escape areas of higher temperature.

### SUMMARY OF INVENTION

In one aspect, embodiments disclosed herein relate to a barrier disposed within a computer housing, comprising: a frame adapted to be secured to the computer housing; and a plurality of elongated members attached to the frame; wherein the plurality of elongated members are disposed across the frame such that the plurality of elongated members are attached to an inner surface of the frame, wherein the barrier defines separate compartments within the computer housing, and wherein at least one fan is disposed in a compartment separated by the barrier from another compartment in which at least one electronic component is disposed.

In one aspect, embodiments disclosed herein relate to a method of manufacturing a barrier to be used within a computer housing, the method comprising: providing a frame; attaching a plurality of elongated members to an inside surface of the frame such that the plurality of elongated members are disposed across the frame; disposing the frame within the housing such that the frame defines separate compartments within the housing; disposing at least one fan in a compartment separated by the barrier from another compartment; and disposing at least one electronic component in the another compartment.

In one aspect, embodiments disclosed herein relate to a A barrier to be disposed within a computer housing, the barrier comprising: a metal frame having a generally rectangular shape; and a plurality of elongated members threadedly attached to an inside surface of the frame; wherein the plurality of elongated members are disposed across the frame and are arranged substantially parallel with respect to each other, wherein the barrier defines separate compartments within the computer housing, and wherein at least one fan is disposed in a compartment separated by the barrier from another compartment in which at least one electronic component is disposed.

Other aspects and advantages of the invention will be apparent from the following description and the appended claims.

### BRIEF DESCRIPTION OF DRAWINGS

FIG. 1 shows a perspective view of a prior art barrier.

FIG. 2 shows a perspective view of a barrier in accordance with embodiments disclosed herein.

FIG. 3 shows a detail view of a barrier used in accordance with embodiments disclosed herein.

FIGS. 4A-C show cross-sectional views of elongated members in accordance with embodiments disclosed herein.

FIG. 5 shows a detail view of a barrier used in accordance with embodiments disclosed herein.

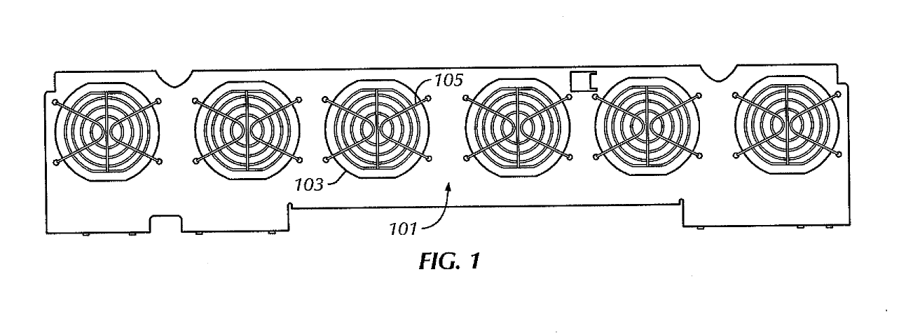

### DETAILED DESCRIPTION

Specific embodiments of the present disclosure will now be described in detail with reference to the accompanying Figures. Like elements in the various Figures may be denoted by like reference numerals for consistency. Further, in the following detailed description of embodiments of the present disclosure, numerous specific details are set forth in order to provide a more thorough understanding of the invention. However, it will be apparent to one of ordinary skill in the art that the embodiments disclosed herein may be practiced without these specific details. In other instances, well-known features have not been described in detail to avoid unnecessarily complicating the description.

In one aspect, embodiments disclosed herein generally relate to a barrier to be used within a housing. The housing may include electrical components disposed therein, such as a computer having hardware components disposed therein, in which the barrier may be used to define separate compartments within the housing such that the electrical components may be separated within the housing as desired and/or protect users from contacting the blades of fans disposed within the housing. The barrier includes a frame and a plurality of elongated members. The elongated members are attached to an inner surface of the frame such that the elongated members extend across the frame. The frame may then have a rectangular cross-section, and the elongated members may be removably attached to the frame. Specifically, the elongated members may be threadedly attached to the frame. Further, one or more of the elongated members may have an aerodynamically shaped cross-section to facilitate and improve airflow across the barrier and within the housing. Furthermore, the elongated members may be arranged substantially parallel with respect to each other and may be disposed with substantially equal distance between each other.

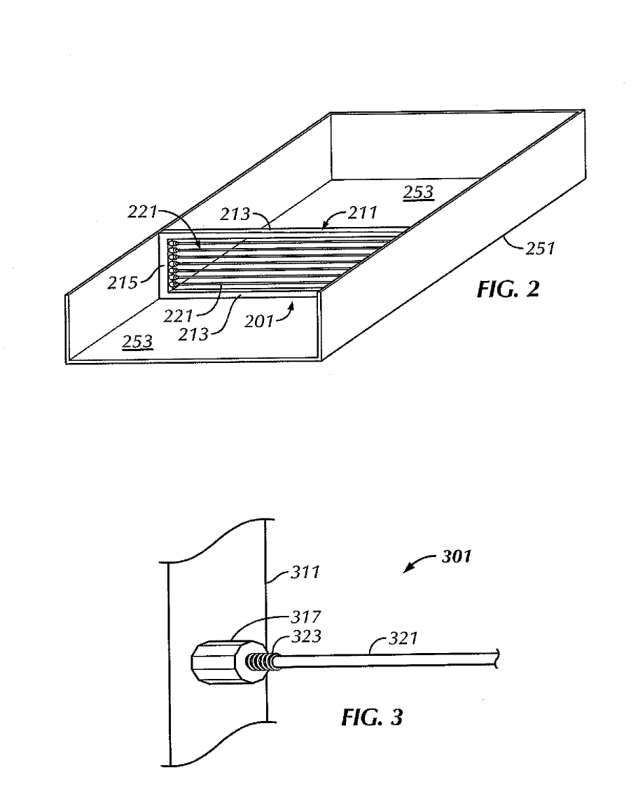

Referring now to FIG. 2, a perspective view of a barrier 201 disposed within a housing 251 in accordance with embodiments disclosed herein is shown. The barrier 201 is disposed within the housing 251 such that multiple compartments 253 are formed within the housing 251. The barrier 201 includes a frame 211 and a plurality of elongated members 221. As shown, the frame 211 may have a rectangular shape, in which the frame 211 may include two longer sides 213 that are attached to two shorter sides 215. With the frame 211 having a substantially similar shape and size with the housing 251, the frame 211 may have a secure fit within the housing 251. Those having ordinary skill in the art will appreciate, though, that the frame is not so limited, as the frame may have any size or shape, such as another geometrical shape, to be disposed within the housing.

The elongated members 211 of the barrier 201 are attached to the frame 211. Specifically, as shown, the elongated members 221 are attached to an inner surface of the frame 211. By attaching the elongated members 221 to an inner surface of the frame 211, the elongated members 221 may be disposed across the frame 211 to provide a substantially planar surface with the barrier 201. In this embodiment, the elongated members 221 are attached to an inner surface of the shorter sides 215 of the frame 211. However, those having ordinary skill in the art will appreciate that the present disclosure is not so limited, and in other embodiments, the elongated members 221 may instead, or in addition, be attached to an inner surface of the longer sides 213 of the frame 211.

Further, as shown, the elongated members 221 may be arranged substantially parallel with respect to each other within the frame 211. In FIG. 2, the elongated members 221 are arranged substantially parallel with the two longer sides 213. However, in another embodiment, the elongated members 221, if attached to the two longer sides 213, may instead be arranged substantially parallel with the two shorter sides 215. Regardless, by having the elongated members 221 arranged substantially parallel with respect to each other and/or the sides 213, 215 of the frame 211, the elongated members 221 may increase and provide more uniform strength to the frame 211.

Furthermore, as shown, the elongated members 221 may be arranged and disposed within the frame 211 such that the elongated members 221 have substantially equal distance between each other. As with the parallel arrangement of the elongated members 221, by having the elongated members 221 arranged with substantially equal distance between each other within the frame 211, the elongated members 221 may increase and provide more uniform strength to the frame 211.

Referring now to FIG. 3, a detail view of an elongated member 321 attached to a frame 311 of a barrier 301 in accordance with embodiments disclosed herein is shown. In this embodiment, the elongated member 321 is removably attached to the frame 311. Specifically, in this embodiment, the elongated member 321 is threadedly attached to the frame 311. For example, the elongated member 321 may have a thread 323 formed at one or both ends thereof. Further, the frame 311 may have a receiving member 317, e.g., a nut, attached thereto, in which the receiving member 317 may have a corresponding thread formed therein. Accordingly, the elongated member 321 may be received within the receiving member 317 through the engagement of the thread 323 on the elongated member 321 and the thread within the receiving member 317. As the threaded engagement is increased, tension across the elongated member 321 is increased.

To engage the elongated member 321 with the receiving member 317, the elongated member 321 may rotate with respect to the receiving member 317. As such, the receiving member 317 may also rotate with respect to the frame 311. In such an embodiment, when engaging the elongated member 321 and the receiving member 317, the elongated member 321 may remain stationary with respect to the frame 311 and the receiving member 317 may be rotated with respect to the frame 311. This may enable tension to be applied to the elongated member 321 across the frame 311. By applying tension to the elongated member 321, the elongated member may increase and provide more uniform strength to the frame 311.

Further, rather than only threaded engagement, other methods may be used to attach the elongated members to the frame. In one embodiment, one or more elongated members may be attached to the frame using a mechanical interference fit. For example, by riveting an elongated member within the frame, or within a receiving member attached to the frame, the elongated member may remain attached to the inner surface of the frame. In another embodiment, one or more elongated members may be attached to the frame using welding and/or an adhesive material. Furthermore, rather than by forming the elongated members and the frame separately, one or more elongated members may instead be monolithically formed with the frame. For example, by using a molding process, the elongated members and the frame may be formed together and attached to each other.

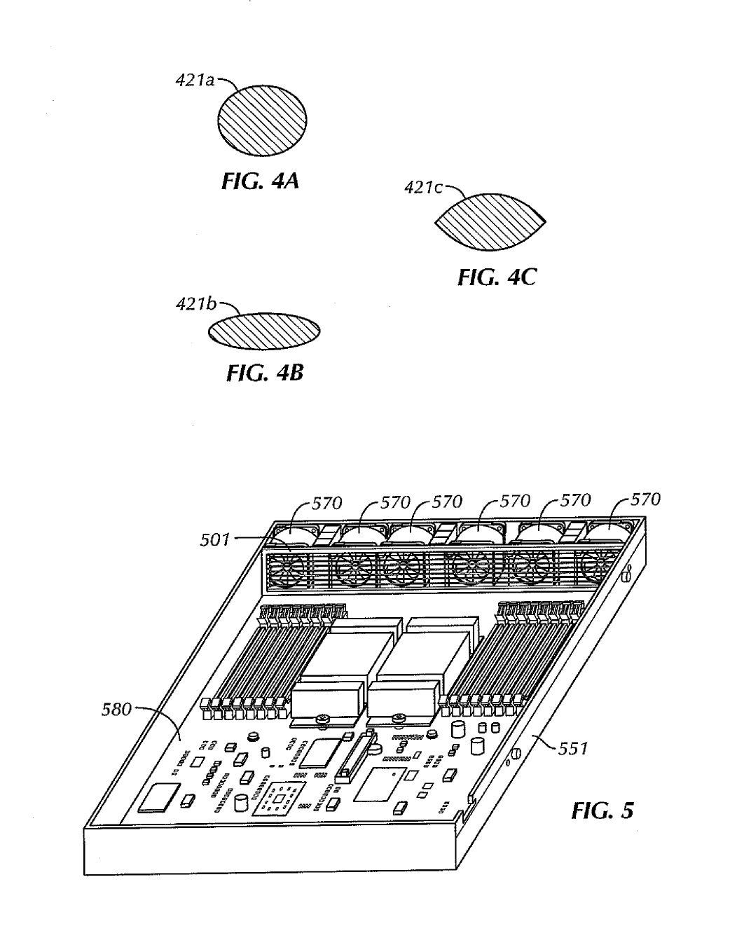

Referring now to FIGS. 4A-4C, multiple cross-sectional views of elongated members 421A-C in accordance with embodiments disclosed herein are shown. In FIG. 4A, a cross-sectional view of the elongated member 421A is shown, in which the elongated member 421A has a circular cross-section. In FIG. 4B, a cross-sectional view of the elongated member 421B is shown, in which the elongated member 421B has an elliptical cross-section. In FIG. 4C, a cross-sectional view of the elongated member 421C is shown, in which the elongated member 421C has a bladed cross-section.

As can be seen in FIG. 5, the barrier 501 may be placed in the housing 551 so as to separate fans 570 from electronic components 580. Because of this configuration, separate compartments are defined inside the housing and users who service the computer and interact with the electronic components 580 in one compartment are prevented from, for example, accidentally contacting the blades of the fans 570 in the other compartment.

As such, preferably the elongated members used within the present disclosure have an aerodynamically shaped cross-section, As used herein, an “aerodynamically shaped” cross-section refers to a cross-section of an elongated member that facilitates airflow across the elongated member. By having an aerodynamically shaped cross-section, this may increase the airflow across the barrier and within the housing that the barrier may be disposed. Those having ordinary skill in the art, though, will appreciate that the present disclosure is not so limited, and any shape may be used for the cross-section of the elongated members, such as a square, rectangular, or triangular cross-section, without departing from the scope of the present disclosure.

The barrier described above may be formed from one or more materials. In one or more embodiments, the frame and/or the elongated members may be formed from or may include metal, such as cast iron or sheet metal. In one or more embodiments, the frame and/or the elongated members may be formed from or may include carbon fiber. In one or more embodiments, the frame and/or the elongated members may be formed from or may include plastic, such as a high-strength plastic. Further, the barrier may include combinations of these materials, such as forming the frame from metal and the elongated members from carbon fiber. Furthermore, those having ordinary skill in the art will appreciate that other materials may be used to form the barrier or portions thereof, such as such as wood, fabrics, ceramics, or any other materials known in the art, without departing from the scope of the present disclosure.

Accordingly, embodiments disclosed herein may provide for one or more of the following advantages. Embodiments disclosed herein may be used to provide a partition and define separate compartments within a housing. For example, within a computer, a barrier in accordance with the present disclosure may define separate compartments within the computer to increase the safety of the electrical components disposed within the computer.

Embodiments disclosed herein may be used to increase airflow within a housing. For example, because of the gaps provided between the elongated members, and because of the aerodynamically shaped cross-sections of the elongated members, the airflow may be increase across the barrier of the present disclosure. This is particularly true in embodiments having elongated members with aerodynamically shaped cross-sections. As the aerodynamic shape of the elongated members is improved, the air passing over the elongated member passes in a more laminar flow. Further, such a laminar airflow increases the efficiency of the cooling of the electronic components in the housing as compared to a more turbulent airflow.

Embodiments disclosed herein may provide for a barrier that has an increased strength and a more uniform strength. For example, by tensioning the elongated members across the frame of the barrier, the strength of the frame and the barrier may be increased. Additionally, a more uniform strength may be provided across the entire frame and barrier.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A barrier disposed within a computer housing, comprising:
a frame adapted to be secured to the computer housing; and
a plurality of elongated members attached to the frame;
wherein the plurality of elongated members are disposed across the frame such that the plurality of elongated members are attached to an inner surface of the frame,
wherein the barrier defines separate compartments within the computer housing, and
wherein at least one fan is disposed in a compartment separated by the barrier from another compartment in which at least one electronic component is disposed.

2. The barrier of claim 1, wherein at least one of the plurality of elongated members comprises an aerodynamically shaped cross-section.

3. The barrier of claim 1, wherein at least one of the plurality of elongated members comprises one of a circular cross-section, an elliptical cross-section, and a bladed cross-section.

4. The barrier of claim 1, wherein the frame comprises a rectangular shape such that two sides of the frame are longer than two other sides of the frame.

5. The barrier of claim 4, wherein the plurality of elongated members are arranged substantially parallel with respect to each other.

6. The barrier of claim 5, wherein the plurality of elongated members are arranged one of substantially parallel with the two longer sides of the frame or substantially parallel with the two shorter sides of the frame.

7. The barrier of claim 1, wherein the plurality of elongated members are attached in tension across the frame.

8. The barrier of claim 1, wherein the plurality of elongated members are disposed with substantially equal distance therebetween.

9. The barrier of claim 1, wherein at least one of the plurality of elongated members is removably attached to the frame.

10. The barrier of claim 9, wherein the at least one of the plurality of elongated members is threadedly attached to the frame.

11. The barrier of claim 1, wherein at least one of the plurality of elongated members is monolithically formed with the frame.

12. The barrier of claim 1, wherein one of the frame and the plurality of elongated members comprises metal.

13. A method of manufacturing a barrier to be used within a computer housing, the method comprising:
providing a frame;
attaching a plurality of elongated members to an inside surface of the frame such that the plurality of elongated members are disposed across the frame;
disposing the frame within the housing such that the frame defines separate compartments within the housing;
disposing at least one fan in a compartment separated by the barrier from another compartment; and
disposing at least one electronic component in the another compartment.

14. The method of claim 13, wherein at least one of the plurality of elongated members is removably attached to the frame.

15. The method of claim 14, wherein the at least one of the plurality of elongated members is threadedly attached to the frame.

16. The method of claim 13, attaching the plurality of elongated members across the frame so as to be in tension.

17. The method of claim 13, arranging the plurality of elongated members substantially parallel with respect to each other.

18. The method of claim 13, wherein at least one of the plurality of elongated members comprises an aerodynamically shaped cross-section.

19. The method of claim 13, wherein at least one of the plurality of elongated members comprises one of a circular cross-section, an elliptical cross-section, and a bladed cross-section.

20. A barrier to be disposed within a computer housing, the barrier comprising:
a frame having a generally rectangular shape; and
a plurality of elongated members threadedly attached to an inside surface of the frame;
wherein the plurality of elongated members are attached across the frame in tension and are aerodynamically shaped,
wherein the barrier defines separate compartments within the computer housing, and
wherein at least one fan is disposed in a compartment separated by the barrier from another compartment in which at least one electronic component is disposed.
